(19) United States
(12) Patent Application Publication
(10) Pub. No.: US 2005/0163958 A1
(43) Pub. Date: Jul. 28, 2005

(54) Optical filter and display using the same

(76) Inventor: Yuji Nakatsugawa, Tokyo-To (JP)

Correspondence Address: HARNESS, DICKEY & PIERCE, P.L.C., P.O. BOX 828, BLOOMFIELD HILLS, MI, 48303, US

(21) Appl. No.: 10/972,086

(22) Filed: Oct. 22, 2004

(30) Foreign Application Priority Data
Nov. 13, 2003 (JP) 2003-383685
Dec. 2, 2003 (JP) 2003-403851
Mar. 16, 2004 (JP) 2004-74119

(51) Int. Cl. B32B 9/00

(52) U.S. Cl. 428/40.1

(57) ABSTRACT

The present invention provides an optical filter possessing excellent near infrared shielding properties. The optical filter has a laminate structure comprising at least a transparent substrate and a near infrared absorptive layer, which is formed of an acrylic resin containing a near infrared absorptive colorant capable of absorbing a near infrared radiation, stacked on top of each other. The acrylic resin has a birefringence value of 0 (zero) to 15 nm.

### FIELD OF THE INVENTION

The present invention relates to an optical filter having a near infrared shielding property. The present invention also relates to a display, particularly a plasma display, provided with this optical filter.

### BACKGROUND ART

Electromagnetic waves generated from electric or electronic devices are said to often adversely affect other devices or human body or animals. For example, electromagnetic waves with a frequency of 30 MHz to 130 MHz are generated from a plasma display (hereinafter often abbreviated to “PDP”) and sometimes affect computers or equipment utilizing computers located around the PDP. Therefore, minimizing leakage of generated electromagnetic waves to the exterior has been desired.

In PDP, since a mixed gas composed of neon and xenon is used as discharge gas, a near infrared radiation with a wavelength of 800 nm to 1200 nm is emitted. This near infrared radiation is regarded as having a fear of causing malfunction of various equipment utilizing a near infrared radiation, for example, remote controllers for home electric appliances and communication equipment utilizing a near infrared radiation such as personal computers and cordless telephones or the like. An improvement in this point has also been desired.

In order to overcome the above problems, an electromagnetic wave shielding member has been proposed. In this electromagnetic wave shielding member, an adhesive or a pressure-sensitive adhesive, a metallic thin film mesh, and a flattening layer for flattening the concave-convex face of the mesh are stacked in that order on a transparent substrate film. In this case, an absorbing agent capable of absorbing a specific wavelength in visible light and/or near infrared region is incorporated in the adhesive or pressure-sensitive adhesive, or a flattening layer (see, for example, Japanese Patent Laid-Open No. 311843/2002 (page 4, and FIGS. 7 to 9)). The electromagnetic wave shielding member described in this document has a metallic thin film mesh and thus has an electromagnetic wave shielding property. Further, since an absorbing agent capable of absorbing a specific wavelength in visible light and/or near infrared region is contained, the electromagnetic wave shielding member also has a near infrared shielding property. Therefore, the claimed advantage of the electromagnetic wave shielding member is that the color balance of the display can be improved and, in addition, the contrast can be improved by external light absorption.

Further, a film using a colorant having a near infrared absorptive capability and formed by coating or casting is also known (see, for example, Japanese Patent Laid-Open No. 116826/1999 (page 5 and FIG. 1)).

Japanese Patent Laid-Open No. 174627/2001 proposes a method for improving image quality when an optical filter is disposed on the front face of the display. In this method, a transparent substrate substantially free from particles is used, and an optical strain is reduced by bringing the content of foreign matter having a size of not less than 20 μm to not more than 10/m² per unit area of the film.

In all the above prior art techniques, however, when resins constituting a layer containing an absorbing agent are of some type, problems occur including an image quality problem such as a double image upon the disposition of the optical filter on the front face of the display, a lowering in a near infrared shielding property under high-temperature and humid conditions, and the occurrence of colored or discolored images due to the appearance of particular absorption in a visible region. When solving these problems is attempted, properties inherently possessed by the optical filter include a non-seeing property such that the near infrared absorptive layer and the metallic mesh should not be seen (a nonvisible property), transparency (haze), transmittance in a visible region (luminous transmittance), and shielding property in a near infrared region (near infrared transmittance).

### DISCLOSURE OF THE INVENTION

An object of the present invention is to provide an optical filter which, when disposed on the front face of a display, does not cause image quality problems such as the occurrence of a double image. Another object of the present invention is to provide an optical filter which, under high temperature or humid conditions, does not cause problems such as deteriorated near infrared shielding properties, the appearance of particular absorption in a visible region, coloring or discoloration of images, or a lowering in transparency due to the occurrence of cracks (an increase in haze). Still another object of the present invention is to provide an optical filter with various functions added while solving the above problems. A further object of the present invention is to provide a display, particularly a plasma display, to which these optical filters have been applied.

The present inventor has made various studies with a view to solving the above problems and, as a result, has found that the above problems can be solved by using, as a resin constituting a near infrared absorptive colorant-containing layer, an acrylic resin having a birefringence value on a certain or lower level or an acrylic resin having a glass transition temperature in a predetermined range in addition to the above property. This has led to the completion of the present invention which will be described below.

The first invention relates to an optical filter having a laminate structure comprising at least a transparent substrate and a near infrared absorptive layer, which is formed of an acrylic resin containing a near infrared absorptive colorant capable of absorbing a near infrared radiation, stacked on top of each other, characterized in that said acrylic resin has a birefringence value of 0 (zero) to 15 nm.

The second invention relates to an optical filter characterized in that, in the first invention, said acrylic resin is an acrylic copolymer resin comprising:
(1) methyl methacrylate; and
(2) one or at least two (meth)acrylic acid compounds which can negate a negative birefringence value possessed by said methyl methacrylate to bring the birefringence value of said copolymer to 0 (zero) to 15 nm.

The third invention relates to an optical filter characterized in that, in the first or second invention,
said acrylic resin is an acrylic copolymer resin comprising:
(1) methyl methacrylate; and
(2) one or at least two compounds represented by general formula (1) 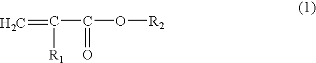
   wherein R² represents a hydrogen atom or an alkyl group; and R² represents an alicyclic group or an aromatic ring group.

The fourth invention relates to an optical filter characterized in that, in the third invention, the compound represented by general formula (1) is at least one compound in which R² represents an alicyclic group, and at least one compound in which R² represents an aromatic ring group.

The fifth invention relates to an optical filter characterized in that, in any one of the first to fourth inventions,
said acrylic resin has a glass transition temperature of 80° C. to 150° C.

The sixth invention relates to an optical filter characterized in that, in any one of the first to fifth inventions,
said near infrared absorptive colorant is a diimmonium compound represented by general formula (2): 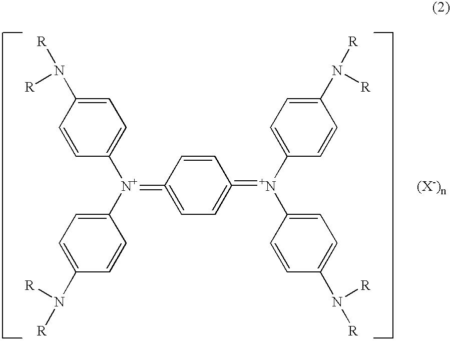
   wherein R's, which may be the same or different, represent hydrogen or an alkyl, aryl, hydroxyl, phenyl, or alkyl halide group; X represents a monovalent or divalent anion; and n is 1 or 2.

The seventh invention relates to an optical filter characterized in that, in any one of the first to sixth inventions,
X in general formula (2) represents a monovalent or divalent anion having a sulfonylimidic acid ion structure represented by general formula (3): 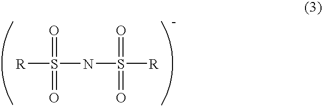
   wherein R's, which may be the same or different, represent hydrogen, a halogen, a substituted or unsubstituted alkyl group, or a substituted or unsubstituted aryl group.

The eighth invention relates to an optical filter characterized in that, in the sixth or seventh invention,
said near infrared absorptive colorant contains a phthalocyanine compound in addition to the diimmonium compound represented by general formula (2).

The ninth invention relates to an optical filter characterized in that, in any one of the first to eighth inventions,
the content of foreign matter, of which the maximum diameter per unit area of said near infrared absorptive layer is 0.2 μm to 30 μm, is not more than 40/m².

The tenth invention relates to an optical filter characterized in that, in the ninth invention, the content of foreign matter, of which the maximum diameter per unit area of said near infrared absorptive layer is 3 μm to 12 μm, is 1/m² to 20/m².

The eleventh invention relates to an optical filter characterized in that, in any one of the first to tenth inventions,
the optical filter further comprises one or at least two layers having one or at least two functions of an electromagnetic wave shielding function, a color tone regulating function, a neon light shielding function, an antireflective function, an anti-glaring function, and an anti-smudging function.

The twelfth invention relates to an optical filter characterized in that, in any one of the first to eleventh inventions,
the optical filter further comprises a pressure-sensitive adhesive layer for application to an object, or a release film for said pressure-sensitive adhesive layer and for protecting said pressure-sensitive adhesive layer.

The thirteenth invention relates to a display characterized by
comprising the optical filter according to any one of the first to twelfth inventions disposed on the front face of a display.

According to the first invention, the near infrared absorptive layer in the optical filter contains a near infrared absorptive colorant, and the binder resin is an acrylic resin having a birefringence value of 0 (zero) to 15 nm. By virtue of this constitution, when the optical filter is disposed on the front face of a display, the occurrence of a double image can be suppressed and, advantageously, high-definition image quality can be realized.

The second invention uses, as the acrylic resin, an acrylic copolymer resin comprising methyl methacrylate and a (meth)acrylic acid compound, which can negate a negative birefringence value of methyl methacrylate to bring the birefringence value of the copolymer to 0 (zero) to 15 nm. This constitution can provide, in addition to the effect of the first invention, such an additional effect that, when the optical filter is disposed on the front face of a display, the occurrence of a double image can be more effectively suppressed and a higher-definition image quality can be realized.

According to the third invention, the binder resin in the near infrared absorptive layer comprises, as a constituent unit represented by general formula (1), an alicyclic group- or aromatic ring group-containing (meth)acrylic resin monomer. This constitution can provide, in addition to the effects of the first or second invention, such an effect that the structure is such that a structure having high transparency and a high content of carbon and hydrogen and free from a lone pair is provided and, by virtue of this, the adsorption of moisture in the air in the resin can be suppressed, and the water absorption of the acrylic resin can be lowered, whereby a deterioration in the near infrared absorptive colorant as a result of a reaction of the near infrared absorptive colorant with water can be prevented and a near infrared absorptive capability can be stably provided even under high temperature and high humidity conditions. Further, the use of an alicyclic or aromatic ring group-containing acrylic resin monomer represented by general formula (1) as a constituent unit in the copolymer resin can also effectively increase the glass transition temperature of the acrylic resin.

Further, according to the third invention, the effect of suppressing a lowering in mechanical strength such as breaking strength at bending of the optical filter can also be attained through the copolymerization of the compound represented by general formula (1) with methyl methacrylate.

According to the fourth invention, an alicyclic group-containing (meth)acrylic resin monomer and an aromatic ring group-containing (meth)acrylic resin monomer are used in the R part in the constituent unit represented by general formula (1). By virtue of this constitution, in addition to the effect of the third invention, the effect of negating the negative birefringence value possessed by methyl methacrylate to easily bring the birefringence value of the copolymer to 0 (zero) to 15 nm can be attained.

According to the fifth invention, the range of the glass transition temperature of the acrylic resin has been specified more strictly than conventional service conditions. This constitution can provide, in addition to any of the effects of the first to fourth inventions, such an effect that a reaction between near infrared absorptive colorants or a reaction between a near infrared absorptive colorant with an acrylic resin around the colorant can be suppressed and, thus, the heat resistance of the optical filter can be improved to a level which is satisfactory from the practical point of view.

According to the sixth invention, a diimmonium compound represented by general formula (2) is used as a near infrared absorptive colorant. This constitution can provide, in addition to the effects of the first to fifth inventions, such an effect that the near infrared absorption function of the optical filter can be stably attained for a long period of time.

According to the seventh invention, the near infrared absorptive colorant is a diimmonium compound, and X in general formula (2) has a sulfonylimidic acid ion skeleton represented by general formula (3). This constitution provides, in addition to the effects of the first to sixth inventions, such an effect that the near infrared absorbing function of the optical filter can be stably exhibited for a longer period of time.

According to the eighth invention, the diimmonium compound is used in combination with a phthalocyanine compound as the near infrared absorptive colorant. This constitution provides, in addition to the effects of the sixth or seventh invention, such an effect that the near infrared absorption of the optical filter can be enhanced over the whole near infrared region.

According to the ninth invention, the content of foreign matter having a maximum diameter of 0.2 μm to 30 μm per unit area of the optical function layer is specified to not more than 40/m². This constitution provides, in addition to any of the effects of the first to eighth inventions, such an effect that a deterioration in the optical function layer in the optical filter with the elapse of time and an increase in haze are less likely to occur, and excellent transparency can be exhibited for a long period of time.

According to the tenth invention, the content of foreign matter having a maximum diameter of 3 μm to 12 μm per unit area of the optical function layer is specified to 1 to 20/m². This constitution provides, in addition to the effect of the ninth invention, such an effect that a deterioration in the optical function layer in the optical filter with the elapse of time and an increase in haze are much less likely to occur, and excellent transparency can be exhibited for a longer period of time.

According to the eleventh invention, the optical filter comprises one or at least two layers having one or at least two functions of an electromagnetic wave shielding function, a color tone regulating function, a neon light shielding function, an antireflective function, an anti-glaring function, and an anti-smudging function. The eleventh invention can exhibit the effect of any of the first to tenth inventions.

According to the twelfth invention, the optical filter further comprises a pressure-sensitive adhesive layer, or a pressure-sensitive adhesive layer in combination with a release film. This constitution provides, in addition to any of the effects of the first to eleventh inventions, such an effect that the optical filter can easily be applied to an object.

According to the thirteenth invention, a display comprising the optical filter of the present invention provided on its front face can exhibit the effect of any of the first to twelfth inventions.

### BRIEF DESCRIPTION OF THE DRAWINGS

FIG. 1 is a schematic cross-sectional view showing one embodiment of the optical filter according to the present invention;

FIG. 2 is a schematic cross-sectional view showing another embodiment of the optical filter according to the present invention; and

FIG. 3 is a diagram showing a plasma display having the optical filter according to the present invention disposed on its front face.

### BEST MODE FOR CARRYING OUT THE INVENTION

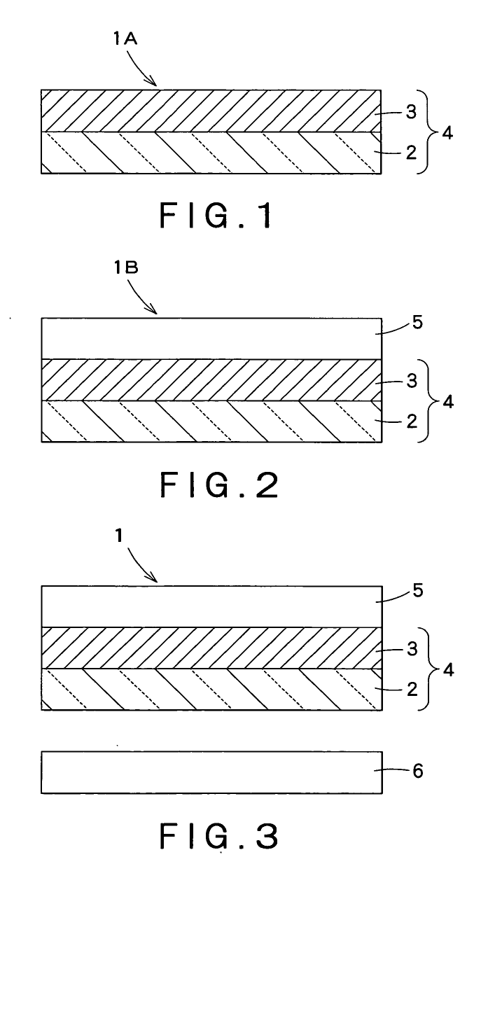

FIGS. 1 and 2 are cross-sectional views illustrating embodiments of a laminate structure of the optical filter according to the present invention. As indicated by a symbol 1A in FIG. 1, the optical filter according to the present invention most basically comprises a near infrared absorptive laminate 4 having a laminate structure comprising a near infrared absorptive layer 3 provided on a transparent substrate 2. This transparent substrate 2 may have been subjected to treatment for improving the adhesion in the lamination.

One or at least two layers of various layers known in the field of the optical filter may be added to the near infrared absorptive laminate 4 shown in FIG. 1, and the provision of these additional layers can realize the construction of an optical filter with additional functions. Specifically, as shown in FIG. 2, one or more other optical function layers 5, for example, one or at least two function layers selected from an electromagnetic wave shielding layer capable of cutting off an electromagnetic wave, a color tone regulating layer for regulating a color tone of light emitted from a display, a neon light shielding layer for cutting off unnecessary luminescence around 595 nm emitted by excitation of neon gas in a plasma display, an anti-smudging layer for preventing fouling during use, and other layers such as antireflective layer and an anti-glaring layer may be stacked on the near infrared absorptive layer 3 side of the near infrared absorptive laminate 4, that is, the upper side in the drawing. These function layers 5 may be stacked only on the underside of the transparent substrate 2, or may be stacked on both upper and lower sides, or may be stacked between the transparent substrate 2 and the near infrared absorptive layer 3.

In the optical filters 1A, 1B with or without the above various layers, a pressure-sensitive adhesive layer may be stacked on one or both sides thereof so that the optical filters can be applied to any desired face of an object. When the pressure-sensitive adhesive layer in an exposed state, the optical filters are difficult to handle. Therefore, a method is preferably adopted in which a release sheet is in the state of being stacked on the pressure-sensitive adhesive layer immediately before the application. The optical filters 1A, 1B which can take these various structures can be applied to various types of displays. For example, as shown in FIG. 3, in use, the optical filter can be disposed on the front face (a face on the viewer side) of a plasma display (PDP) 6. In use, an optical filter 1 with a pressure-sensitive adhesive layer (not shown) stacked thereon can be applied directly on the front face of the plasma display 6. The pressure-sensitive adhesive layer is in many cases applied onto one side of the optical filter 1. Alternatively, a pressure-sensitive adhesive may be applied on both sides of the optical filter, and this optical filter with the pressure-sensitive adhesive applied on both sides thereof can be used in such a manner that the pressure-sensitive adhesive layer applied on one side of the optical filter is applied onto a display while a film having other function is applied onto the pressure-sensitive adhesive layer provided on the other side of the optical filter.

The transparent substrate 2 and the near infrared absorptive layer 3 constituting the optical filter 1 according to the present invention and materials, lamination methods and the like of individual layers which may be added to the fundamental laminate structure as described above will be described in detail.

Near Infrared Absorptive Layer:

The near infrared absorptive layer 3 is basically formed of a transparent binder resin containing a near infrared absorptive colorant capable of absorbing a near infrared radiation.

In the case of a typical application of the optical filter 1 in which the optical filter 1 is applied on the front face of a plasma display 6, as described above, a near infrared radiation produced in luminescence in the plasma display 6 utilizing xenon gas discharge has a fear of causing malfunction of various devices. Therefore, the near infrared absorptive layer 3 in the optical filter 1 should absorb a near infrared region, that is, a wavelength region of 800 nm to 1200 nm. The light transmittance in this wavelength region is preferably not more than 20%, more preferably not more than 10%.

At the same time, the near infrared absorptive layer 3 should have a satisfactory light transmittance in a visible light region, that is, in a wavelength region of 380 nm to 780 nm.

The light transmittance in both the above wavelength regions has been measured with a spectrophotometer (stock number: “UV-3100 PC,” manufactured by Shimadzu Seisakusho Ltd.).

(i) Near Infrared Absorptive Colorant

Specific examples of inorganic near infrared absorptive colorants usable as the near infrared absorptive colorant include tin oxide, indium oxide, magnesium oxide, titanium oxide, chromium oxide, zirconium oxide, nickel oxide, aluminum oxide, zinc oxide, iron oxide, antimony oxide, lead oxide, bismuth oxide, and lanthanum oxide. Specific examples of organic near infrared absorptive colorants usable as the near infrared absorptive colorant include cyanine compounds, phthalocyanine compounds, naphthalocyanine compounds, naphthoquinone compounds, anthraquinone compounds, aminium compounds, pyrilium compounds, cerylium compounds, squalirium compounds, diimmonium compounds, copper complexes, nickel complexes, and dithiol metal complexes.

These near infrared absorptive colorants may be used solely or in a combination of two or more. Among them, the inorganic near infrared absorptive colorant is preferably in the form of fine particles having an average particle diameter of 0.005 μm to 1 μm, more preferably 0.05 μm to 1 μm, most preferably 0.05 μm to 0.5 μm.

Among others, diimmonium compounds are preferred as the near infrared absorptive colorant used in the optical filter 1 of the present invention. The reason for this is that the diimmonium compound has large absorption of about 100000 in terms of molar absorption coefficient ε in the near infrared region and the visible light transmittance is better than other near infrared absorptive colorants although the diimmonium compound has slight light absorption around wavelength 400 nm to 500 nm in the visible light region.

Preferred diimmonium compounds are those represented by general formula (2). In general formula (2), R's, which may be the same or different, represent hydrogen or an alkyl, aryl, hydroxyl, phenyl, or alkyl halide group. Among them, a substituted or unsubstituted alkyl group or a substituted or unsubstituted aryl group is more preferred. Still more preferred are ethyl, n-propyl, n-butyl, n-pentyl, ethylphenyl, and dimethyl ethylphenyl groups. In particular, ethyl, n-propyl, n-butyl, and ethyl phenyl groups are preferred. When these diimmonium compounds are used, the near infrared absorption of the optical filter is advantageously stable for a long period of time.

X⁻ in general formula (2) is a monovalent or divalent anion. n is 1 in the case of a monovalent anion while n is ½ in the case of a divalent anion. Monovalent anions include, for example, monovalent anions of organic acids and inorganic monovalent anions.

The above X⁻ is preferably a monovalent or divalent anion having a sulfonylimidic acid ion skeleton represented by general formula (3). When these diimmonium compounds are used, the near infrared absorption of the optical filter is advantageously stable for a longer period of time. In general formula (3), R's, which may be the same or different, represent hydrogen, a halogen, a substituted or unsubstituted alkyl group, or a substituted or unsubstituted aryl group. Halogen atoms include fluorine, chlorine, bromine, and iodine atoms. Examples of the substituted or unsubstituted alkyl group include straight, branched, or cyclic hydrocarbon groups with 1 to 20 carbon atoms, such as methyl, ethyl, n-propyl, iso-propyl, n-butyl, iso-butyl, sec-butyl, t-butyl, n-pentyl, iso-pentyl, neo-pentyl, 1,2-dimethylpropyl, n-hexyl, cyclohexyl, 1,3-dimethylbutyl, 1-iso-propylpropyl, 1,2-dimethylbutyl, n-heptyl, 1,4-dimethylpentyl, 2-methyl-1-iso-propylpropyl, 1-ethyl-3-methylbutyl, n-octyl, 2-ethylhexyl, 3-methyl-1-iso-propylbutyl, 2-methyl-1-iso-propyl, 1-t-butyl-2-methylpropyl, n-nonyl, and 3,5,5-trimethylhexyl groups; and alkyl halide groups, such as chloromethyl, 2,2,2-trichloroethyl, trifluoromethyl, 2,2,2-trifluoroethyl, and 1,1,1,3,3,3-hexafluoro-2-propyl groups.

Examples of the substituted or unsubstituted aryl group include phenyl, phenyl halide such as chlorophenyl, dichlorophenyl, trichlorophenyl, bromophenyl, fluorophenyl, pentafluorophenyl, and phenyl iodide, or alkyl derivative-substituted phenyl groups such as tolyl, xylyl, mesityl, ethylphenyl, dimethylethylphenyl, iso-propylphenyl, t-butylphenyl, t-butylmethylphenyl, octylphenyl, nonylphenyl, and trifluoromethylphenyl groups. Among them, more preferred are alkyl halides such as chloromethyl, 2,2,2-trichloroethyl, trifluoromethyl, 2,2,2-trifluoroethyl, and 1,1,1,3,3,3-hexafluoro-2-propyl groups, and particularly preferred are fluorine-substituted alkyls such as trifluoromethyl, 2,2,2-trifluoroethyl, and 1,1,1,3,3,3-hexafluoro-2-propyl groups. Specific examples of diimmonium compounds with an anion introduced thereinto represented by general formula (3) in which R represents a trifluoromethyl group include compounds in which R in general formula (2) represents an n-butyl group or an ethylphenyl group. Specific examples of the latter diimmonium compound with an anion introduced thereinto represented by general formula (3) in which R represents a 1,1,1,3,3,3-hexafluoro-2-propyl group include compounds in which R in general formula (2) represents an n-butyl group.

Diimmmonium compounds represented by general formula (2) may be produced, for example, by the following method described in Japanese Patent Publication No. 25335/1968. Specifically, a compound in which all the substituents (R) are identical (hereinafter referred to as “wholly substituted compound”) can be prepared by subjecting p-phenylenediamine and 1-chloro-4-nitrobenzene to an Ullmann reaction, reducing the product to give an amino compound, and reacting the amino compound with a halogenated compound corresponding to desired R in general formula (2) (for example, BrCH₂CH₂CH₂CH₃ when R is n-C₄H₉) in an organic solvent, preferably a water-soluble polar solvent such as dimethylformamide (DMF), at 30 to 160° C., preferably 50 to 140° C.

A compound other than the wholly substituted compound, for example, a compound in which, among eight R's, seven R's represent iso-C₄H₉ with the remaining one R representing n-C₄H₉, may be synthesized by previously introducing an iso-C₄H₉ group into seven R's among the eight R's, by a reaction with a predetermined number of moles (7 moles per mole of the above amine compound) of a reagent (BrCH₂CH(CH₃)₂), and then reacting the product with a corresponding reagent (BrC₄H₉) in a number of moles (one mole per mole of the above amine compound) necessary for introducing the remaining substituent (n-C₄H₉). Any desired compound other than the wholly substituted compound can be prepared in the same manner as in the production method of the exemplified compound.

Thereafter, the compound synthesized above is oxidized in an organic solvent, preferably in a water-soluble polar solvent such as DMF, at 0 to 100° C., preferably 5 to 70° C., in the presence of an oxidizing agent (for example, a silver salt) corresponding to X in general formula (2). When the amount of the oxidizing agent is 2 equivalents, a diimmonium salt compound represented by general formula (2) is obtained while, when the amount of the oxidizing agent is 1 equivalent, a monovalent aminum salt compound (hereinafter referred to as “aminum compound”) is obtained. The compound represented by general formula (2) may also be synthesized by a method in which the compound synthesized above is oxidized with an oxidizing agent such as silver nitrate, silver perchlorate, or cupric chloride, and an acid or salt of a desired anion is then added to the reaction solution for salt exchange.

As described above, one near infrared absorptive colorant or a mixture of two or more near infrared absorptive colorants may be used in the near infrared absorptive layer 3. When a diimmonium compound as a preferred near infrared absorptive colorant is used, the absorption coefficient around 800 nm to 1000 nm of the diimmonium compound is not necessarily large. Therefore, a large amount of the diimmonium compound should be used for satisfactorily absorbing the near infrared radiation. Accordingly, in order to broaden the near infrared absorption wavelength region of the near infrared absorptive layer 3 or to regulate a color (=apparent color) of the near infrared absorptive layer 3, the incorporation of a near infrared absorptive colorant other than the diimmonium compound is preferred. For example, a phthalocyanine compound or dithiol metal complex having an absorption maximum at 750 nm to 1000 nm may be used in combination with the diimmonium compound. Some dithiol metal complexes, when used in combination with the diimmonium compound, causes a lowering or deterioration in near infrared absorptive properties. Therefore, the combined use of the diimmonium compound and the phthalocyanine compound is more preferred. Phthalocyanine compounds having an absorption maximum at 750 to 1000 nm include YKR 3070, YKR 2900, or YKR 3181, manufactured by Yamamoto Chemical Inc., or IR-1, IR-2, IR-3, 801K, 802K, 803K, HA-1, IR-10A, IR12, or IR14, manufactured by Nippon Shokubai Kagaku Kogyo Co., Ltd.

(ii) Acrylic Resin

The acrylic resin as the binder resin used in the near infrared absorptive layer 3 is a highly transparent resin having a birefringence value of 0 to 15 nm. When the birefringence value is brought to 0 to 15 nm, the occurrence of a double image is suppressed in the case where the optical filter is disposed on the front face of the display, whereby high-definition and highly transparent image quality can advantageously be provided.

The acrylic resin as the binder resin is preferably an acrylic copolymer resin comprising methyl methacrylate and an (meth)acrylic acid compound which can negate a negative birefringence value possessed by the methyl methacrylate to bring the birefringence value of the copolymer to 0 (zero) to 15 nm. More preferably, the acrylic resin as the binder resin is an acrylic copolymer resin, which comprises methyl methacrylate and a (meth)acrylic acid compound represented by general formula (1) and has a birefringence value of 0 to 15 nm.

The acrylic resin is a resin having a high light transmittance in a visible light region and possesses excellent weathering resistance and moldability and kinetic properties such as tensile strength and is thus suitable for optical filters. The average molecular weight of the acrylic resin as the binder resin in the near infrared absorptive layer of the optical filter according to the present invention is preferably 500 to 600000, more preferably 10000 to 400000. When the average molecular weight is in the above-defined range, the above properties such as transparency, weathering resistance, moldability, and tensile strength are excellent.

The birefringence value of the acrylic resin used in the present invention is 0 to 15 nm, preferably 0 to 10 nm, more preferably 0 to 5 nm. The reason for this is as follows. When the disposition of the optical filter according to the present invention on the front face of a display is taken into consideration, the use of a resin having a birefringence value of more than 15 nm causes a double image and thus cannot provide a high-definition image. In the case of a resin having a birefringence value of less than 0.1 nm, however, very close regulation and control are necessary in the production thereof. This enhances the production cost, and, thus, the birefringence value is more preferably not less than 0.1 nm from the viewpoint of production of the acrylic resin.

Birefringence is a phenomenon that, upon the incidence of light on a material having an anisotropic refractive index from the direction of Z axis, phase shifting occurs in light having a plane of polarization in the direction of X axis and light having a plane of polarization in the direction of Y axis. This phenomenon can be found, for example, in calcite. The occurrence of birefringence leads to the occurrence of a double image and thus possibly becomes a severe trouble in display applications. For example, in the case of an acrylic resin consisting of methyl methacrylate only, the birefringence value is highly birefringent and is 50 nm in a negative direction (a value obtained by measuring a phase difference of a single path of an He-Ne laser at a part (5 mm) near a gate in an injection molded product; see Purasuchikku Eigi (PLASTICS AGE) 1999. January. p. 134-138), and, thus, a high-definition image cannot be provided. In general, in the resin, repeating units constituting the resin are somewhat polar, and, thus, the resin is anisotropic in refractive index. When the resin has a molecular chain in a random coil form and is amorphous as a whole, birefringence does not occur. Even in this resin, however, upon experience of a working process which applies shearing force to the resin, such as injection molding, the molecular chain is stretched, disadvantageously resulting in the occurrence of birefringence.

The birefringence value is given by theoretical equation 1.
Δn=Δn_{A}f_{A}+Δn_{B}f_{B} equation 1
wherein Δn_{A} and Δn_{B} represent the intrinsic birefringence value of resin A and the intrinsic birefringence value of resin B, respectively, and f_{A} and f_{B} represent the degree of orientation of resin A and the degree of orientation of resin B, respectively.

Resins having low birefringence can be designed, for example, by the following methods: (1) a random copolymerization method, (2) a blending method, and (3) novel development of low-birefringence monomer.

According to the random copolymerization method (1), a low birefringence value of 0 to 15 nm can be realized by random copolymerization of a monomer resin having a positive birefringence value with a monomer resin having a negative birefringence value.

Monomer resins having a negative birefringence value include (meth)acrylic esters such as methyl methacrylate and methyl acrylate, styrene, α-methyl styrene, acrylonitrile, methacrylonitrile, 2-vinylpyridine, vinyinaphthalene, cellulose ester, and fluorene ring-containing compounds.

Monomer resins having a positive birefringence value include olefin compounds (ethylene and propylene compounds), carbonate compounds, ester compounds, vinyl chloride compounds, vinyl alcohol compounds, cellulose compounds, ethylene-terephthalate compounds, ethylene-naphthalate compounds, sulfone compounds, ether sulfone compounds, allyl sulfone compounds, arylate compounds, imide compounds, amide-imide compounds, maleimides, norbornene compounds, trifluoroethyl methacrylate, benzyl methacrylate, phenylene oxide compounds, and phenylene-sulfide compounds.

The principle of the method (2) based on the blending technique is the same as that of the copolymerization method, and a polymer resin having a positive birefringence value is combined with a polymer resin having a negative birefringence value.

The method (3) based on the new development of the low-birefringence monomer resin can be carried forward by developing a monomer resin having a low-polarizability, bulky alicyclic group or aromatic ring group in its molecular structure, because the inherent birefringence value has a positive correlation with the polarizability of the monomer. Further, a high level of water vapor barrier can be achieved by incorporating a bulky alicyclic or aromatic ring group in a molecular structure.

The transparent binder resin used in the near infrared absorptive layer 3 should also have the function of suppressing a deterioration in a near infrared absorptive colorant under high temperature and high humidity conditions. The near infrared absorptive colorant is deteriorated as a result of a reaction with moisture in the air. The acrylic resin which is particularly preferred as the transparent binder resin used in the near infrared absorptive layer 3 in many cases has high transparency, but on the other hand, the water absorption level is high. This is because the acrylic resin is characterized by having a higher oxygen atom content than other resins. When a lone electron pair possessed by an oxygen atom or the like is present, water molecules are adsorbed by intermolecular force or hydrogen bond. Due to this nature, conventional acrylic resins have a poor water vapor barrier property and are likely to cause a deterioration in colorant. Accordingly, when an acrylic resin is used, preferably, the acrylic resin used contains a substituent of which the content of carbon and hydrogen free from a lone electron pair is high, from the viewpoint of enhancing the level of water vapor barrier property. This substituent can be realized by incorporating a bulky alicyclic or aromatic ring group in a molecular structure of the acrylic resin.

An example of the acrylic resin containing an alicyclic or aromatic ring group is an acrylic resin comprising constituent units represented by general formula (1). In general formula (1), R¹ represents a hydrogen atom or an alkyl group, and R² represents an alicyclic or aromatic ring group.

Examples of the alkyl group in the substituent R¹ of the acrylic resin include methyl, ethyl, n-propyl, and n-butyl groups.

Representative examples of preferred constituent units of the alicyclic acrylic resin in the case where the substituent R² in the acrylic resin is an alicyclic group include cyclopenthyl methacrylate, cyclohexyl methacrylate, methylcylcohexyl methacrylate, trimethylcyclohexyl methacrylate, norbornyl methacrylate, norbornyl methyl methacrylate, cyanonorbornyl methacrylate, phenyl norbornyl methacrylate, isobornyl methacrylate, bornyl methacrylate, menthyl methacrylate, phenthyl methacrylate, adamantyl methacrylate, dimethyl adamantyl methacrylate, tricyclodecyl methacrylate, tricyclodecyl-4-methyl methacrylate, and cyclodecyl methacrylate. Tricyclodecyl methacrylate, isobornyl methacrylate, and cyclohexyl methacrylate have satisfactory heat resistance by virtue of their high glass transition point (Tg) and have such a property that moisture and the like causative of the acceleration of a deterioration in colorants are less likely to enter the resin layer. Therefore, they have excellent resistance to moist heat and a low birefringence value and thus are particularly preferred.

Representative examples of preferred constituent units of the aromatic-substituted acrylic resin in the case where the substituent R² in the acrylic resin is an aromatic ring group include benzyl methacrylate, phenyl methacrylate, naphthyl methacrylate, benzyl acrylate, phenyl acrylate, and naphtyl acrylate.

The acrylic resin used in the present invention may be one prepared by homopolymerization of the acrylic resin monomer in the above constituent unit as the monomer component of the acrylic resin containing the alicyclic group or the aromatic ring group, or alternatively may be one prepared by copolymerization of two or more acrylic resin monomers having the above constitution. Further, in order to suppress a lowering in mechanical strength such as breaking strength at bending, the acrylic resin used in the present invention may be prepared by copolymerizing the above constituent unit with other monomer component other than the above constituent unit.

Such copolymerizable other monomer components are not particularly limited so far as they do not sacrifice the transparency, birefringence, heat resistance, and low hygroscopicity of the optical polymer. Examples thereof include acrylic esters, such as methyl acrylate, ethyl acrylate, n-propyl acrylate, i-propyl acrylate, n-butyl acrylate, i-butyl acrylate, t-butyl acrylate, pentyl acrylate, n-hexyl acrylate, 2-ethylhexyl acrylate, n-octyl acrylate, dodecyl acrylate, octadecyl acrylate, butoxyethyl acrylate, glycidyl acrylate, and 2-hydroxyethyl acrylate; methacrylic esters, such as ethyl methacrylate, n-propyl methacrylate, i-propyl methacrylate, n-butyl methacrylate, i-butyl methacrylate, t-butyl methacrylate, pentyl methacrylate, n-hexyl methacrylate, 2-ethylhexyl methacrylate, n-octyl methacrylate, dodecyl methacrylate, octadecyl methacrylate, butoxyethyl methacrylate, glycidyl methacrylate, and 2-hydroxyethyl methacrylate; aromatic vinyl compouds such as 4-vinylpyridine, 2-vinylpyridine, α-methyl styrene, α-ethyl styrene, α-fluorostyrene, α-chlorostyrene, α-bromostyrene, fluorostyrene, chlorostyrene, bromostyrene, methyl styrene, methoxy styrene, and styrene; (meth)acrylamides, such as acrylamide, methacrylamide, N-dimethylacrylamide, N-diethylacrylamide, N-dimethylmethacrylamide, and N-diethylmethacrylamide; metal (meth)acrylates, such as calcium acrylate, barium acrylate, lead acrylate, tin acrylate, zinc acrylate, calcium methacrylate, barium methacrylate, lead methacrylate, tin methacrylate, and zinc methacrylate; unsaturated fatty acids, such as acrylic acid and methacrylic acid; and vinyl cyanide compounds, such as acrylonitrile and methacrylonitrile. They may be used either solely or in a combination of two or more.

Among them, acrylic acid, methyl acrylate, ethyl acrylate, n-propyl acrylate, i-propyl acrylate, methacrylic acid, ethyl methacrylate, n-propyl methacrylate, i-propyl methacrylate, 4-vinylpyridine, and acrylamide and the like are preferred. Methyl methacrylate is particularly preferred because it is easily soluble in organic solvents, is easily available, and can impart flexibility to the resin.

When the alicyclic group-containing acrylic resin monomer component having a low birefringence value is copolymerized with other resin monomer component, more preferably, a component which negates the birefringence value of other resin monomer component to be copolymerized is further copolymerized.

For example, in such a case where, when methyl methacrylate is copolymerized with an acrylic resin monomer component containing an alicyclic group with a low birefringence value due to a negative birefringence value of methyl methacrylate, additional copolymerization of benzyl methacrylate having a positive birefringence value results in the formation of a copolymer having a low birefringence value.

In the present invention, the acrylic resin used in the near infrared absorptive layer of the optical filter according to the present invention can be produced by providing preferably 5 to 100 parts by mass, more preferably 5 to 95 parts by mass, still more preferably 10 to 70 parts by mass, most preferably 20 to 40 parts by mass, based on the whole amount (100 parts by mass) of the monomer component, of an alicyclic group- or aromatic ring group-containing (meth)acrylic resin monomer component, providing preferably 95 to 0 (zero) part by mass, more preferably 95 to 5 parts by mass, still more preferably 90 to 30 parts by mass, most preferably 80 to 60 parts by mass, of a (meth)acrylic resin monomer component which is copolymerizable with the alicyclic ring group- or aromatic ring group-containing (meth)acrylic resin component and is other than described above, and copolymerizing both the above monomers or homopolymerizing only the alicyclic ring group- or aromatic ring group-containing (meth)acrylic resin monomer component.

The reason why the amount of the alicyclic ring group- or aromatic ring group-containing (meth)acrylic resin monomer incorporated is preferably 5 to 100 parts by mass based on 100 parts by mass of the total amount of the monomer component, is that, when the amount of the monomer incorporated is less than 5 parts by mass, in some cases, an increase in birefringence value or an increase in hygroscopicity occurs. When the amount of the alicyclic ring group- or aromatic ring group-containing (meth)acrylic resin monomer incorporated exceeds 95 parts by mass, mechanical strength such as breaking strength at bending is sometimes lowered.

On the other hand, the reason why the amount of the (meth)acrylic resin monomer, which is copolymerizable with the alicyclic group- or aromatic ring group-containing (meth)acrylic resin monomer and is other than described above, incorporated is preferably 95 to 0 part by mass based on 100 parts by mass of the total amount of the monomer component is that, when the amount of the copolymerizable monomer incorporated exceeds 95 parts by mass, in some cases, a lowering in heat resistance or an increase in birefringence occurs. When the amount of the copolymerizable monomer incorporated is 0 (zero), in some cases, the regulation of the heat resistance or the hygroscopicity is sometimes difficult.

The acrylic resin used in the optical filter according to the present invention can be produced by any conventional polymerization method such as bulk polymerization, suspension polymerization, or solution polymerization. In particular, the adoption of suspension polymerization or bulk polymerization is preferred, for example, from the viewpoints of transparency and good handleability of the resin.

When the suspension polymerization method is adopted, the addition of a suspending agent and optionally a suspension aid is preferred, because the polymerization is carried out in an aqueous medium. Such suspending agents include water-soluble polymers such as polyvinyl alcohol, methylcellulose, and polyacrylamide, and hardly soluble inorganic materials such as calcium phosphate and magnesium pyrophosphate. The amount of the suspending agent used is not particularly limited. Specifically, when a water-soluble polymer is used, the amount of the water-soluble polymer used is preferably 0.03 to 1% by mass based on the total amount of the monomer component. When a hardly soluble inorganic material is used, the amount of this material used is preferably 0.05 to 0.5% by mass based on the total amount of the monomer component. When a hardly soluble inorganic material is used as the suspending agent, the use of a suspension aid is more preferred. Such suspension aids include anionic surfactants such as sodium dodecylbenzenesulfonate. The amount of the suspension aid used is not also particularly limited. Preferably, however, the amount of the suspension aid used is 0.001 to 0.02% by mass based on the total amount of the monomer component.

The polymerization is preferably carried out in the presence of a radical polymerization initiator. The radical polymerization initiator may be any one which can be used in conventional radical polymerization, for example, organic peroxides, such as benzoyl peroxide, lauroyl peroxide, di-t-butylperoxyhexahydroterephthalate, t-butylperoxy-2-ethylhexanoate, 1,1-t-butylperoxy-3,3,5-trimethylcyclohexane, and t-butylperoxyisopropylcarbonate; azo compounds, such as azobisisobutyronitrile, azobis-4-methoxy-2,4-dimethylvaleronitrile, azobiscyclohexanone-1-carbonitrile, and azodibenzoyl; water-soluble catalysts, such as potassium persulfate and ammonium persulfate; and redox catalysts comprising a combination of a peroxide or a persulfate with a reducing agent.

The amount of the polymerization initiator used is not also particularly limited. Preferably, however, the amount of the polymerization initiator used is 0.01 to 10% by mass based on the total amount of the monomer component. The reason for this is that, when the amount of the polymerization initiator used is less than 0.01% by mass, in some cases, the reactivity is lowered, or the molecular weight of the optical polymer is excessively large. When the amount of the polymerization initiator used exceeds 10% by mass, in some cases, the polymerization initiator remains and lowers optical characteristics.

The use of mercaptan compounds, thioglycol, carbon tetrachloride, α-methylstyrene dimer and the like in combination with quinone compounds or phosphorus compounds as a molecular weight modifier is also preferred. When the conventional molecular weight modifier is added, the regulation of the molecular weight in a predetermined range is easier. The use of various organic solvents is also preferred from the viewpoint of homogeneous polymerization of the monomer component.

Regarding polymerization conditions, the polymerization temperature is preferably 0 (zero) to 200° C. The reason for this is that, when the polymerization temperature is below 0° C., in some cases, the reactivity is significantly lowered and the polymerization time should be prolonged. On the other hand, when the polymerization temperature is above 200° C., in some cases, it is difficult to control the reaction. The polymerization temperature is preferably 40 to 150° C. and more preferably 50 to 100° C. The polymerization time depends upon the polymerization temperature. When the polymerization temperature is 0 (zero) to 200° C., the polymerization time is preferably 1 to 48 hr, more preferably 2 to 24 hr, still more preferably 3 to 12 hr.

The effect of increasing the glass transition temperature of the resin can also be attained by introducing an alicyclic structure into the resin.

In the present invention, when a counter ion-containing near infrared absorptive colorant is contained in the near infrared absorptive layer 3 and, in this case, when the acrylic resin contains a hydroxyl or acid group or when a polymerization initiator or the like is incorporated in the acrylic resin, in some cases, the equilibrium state between the base skeleton of the near infrared absorptive colorant and the counter ion is broken by the hydroxyl group, the acid radical, the polymerization initiator or the like, making it difficult for the near infrared absorptive colorant to exhibit the function of near infrared absorption. From the viewpoint of overcoming this problem, the use of an acrylic resin which is low in either hydroxyl value or acid value is preferred, and the use of an acrylic resin which is low in both hydroxyl value and acid value is more preferred. Among them, near infrared absorptive colorants having a counter ion include diimmonium compounds, nickel complexes, dithiol complexes, aminium compounds, cyanine compounds, or pyrilium compounds.

For the above reason, the hydroxyl value is preferably not more than 10, more preferably not more than 5, and particularly preferably 0 (zero). When the hydroxyl value is reduced in this way, for example, a reaction of, for example, a counter ion-containing near infrared absorptive colorant contained in the near infrared absorptive layer with a hydroxyl group in the acrylic resin can be prevented. Therefore, an optical filter which can stably exhibit a near infrared absorption function even under high temperature and high humidity conditions with the elapse of time can be realized. Further, the range of choice of the near infrared absorptive colorant can be broadened. The term “hydroxyl value” as used herein refers to the number of milligrams of potassium hydroxide necessary for neutralizing acetic acid bonded to the hydroxyl group when 1 g of a sample is acetylated.

Likewise, the acid value is preferably not more than 10, more preferably not more than 5, particularly preferably 0 (zero). When the acid value is reduced in this way, for example, a reaction of the near infrared absorptive colorant with an acid contained in the acrylic resin can be prevented. Therefore, an optical filter which can stably exhibit a near infrared absorption function even under high temperature and high humidity conditions with the elapse of time can be realized. The term “acid value” as used herein refers to the number of milligrams of potassium hydroxide necessary for neutralizing 1 g of a sample.

The glass transition temperature (hereinafter often referred to as “Tg”) of the acrylic resin is preferably a temperature at or above the actual service temperature of the optical filter 1. When the glass transition temperature is a temperature below the actual service temperature of the optical filter 1, in other words, when the optical filter 1 is used at a temperature at or above the glass transition temperature, a reaction occurs between the near infrared absorptive colorants contained in the acrylic resin, or the acrylic resin absorbs moisture in the air. Therefore, a deterioration in the near infrared absorptive colorant or a deterioration in acrylic resin is likely to occur.

From the above viewpoint, preferably, the glass transition temperature of the acrylic resin is, for example, 80 to 150° C., although the glass transition temperature depends upon the value of the actual service temperature of the optical filter 1. When an acrylic resin having a glass transition temperature below 80° C. is used, for example, interaction between the near infrared absorptive colorant and the acrylic resin, or interaction between the near infrared absorptive colorants themselves occurs, resulting in denaturation of the near infrared absorptive colorant. On the other hand, in the case of an acrylic resin having a glass transition temperature above 150° C., when the acrylic resin is dissolved in a solvent to prepare a composition for near infrared absorptive layer formation which is then coated to form a near infrared absorptive layer 3, the drying temperature should be high for thorough drying. Therefore, when the near infrared absorptive colorant has low heat resistance, a deterioration in near infrared absorptive colorant is likely to occur. When a low drying temperature is adopted to avoid this problem, a longer drying time is necessary. Therefore, the efficiency of the drying step is lowered, and the production cost is increased, or drying is unsatisfactory, leading to a deterioration in near infrared absorptive colorant by the solvent remaining unremoved.

The mixing ratio of the near infrared absorptive colorant to the acrylic resin in the near infrared absorptive layer 3 is preferably 0.001 to 100:100, more preferably 0.01 to 50:100, particularly preferably 0.1 to 10:100. The mixing ratio is by mass.

The near infrared absorptive layer 3 is formed by mixing the near infrared absorptive colorant and the acrylic resin with optional other additives together with a solvent and/or a diluent to dissolve or disperse the components to prepare a composition for near infrared absorptive layer formation and coating the composition for near infrared absorptive layer formation thus obtained onto an object. Alternatively, the near infrared absorptive layer 3 may be formed by melt kneading the near infrared absorptive colorant and the acrylic resin with optional other additives to prepare a composition which is then coated by melt extrusion onto an object.

Antioxidants, ultraviolet absorbers or the like may be used as the additive from the viewpoint of improving the durability of the near infrared absorptive layer. Antioxidants include phenolic, amine, hindered phenol, hindered amine, sulfur, phosphoric acid, phosphorous acid, or metal complex antioxidants, and ultraviolet absorbers include benzophenone or benzotriazole ultraviolet absorbers.

When the solubility of the colorant is taken into consideration, solvents usable in the preparation of the composition for near infrared absorptive layer formation include, but are not limited to, acetone, methyl ethyl ketone, methyl isobutyl ketone, ethyl acetate, propyl acetate, benzene, toluene, xylene, methanol, ethanol, isopropanol, chloroform, tetrahydrofuran, N,N-dimethylformamide, acetonitrile, trifluoropropanol, n-hexane or n-heptane, or water.

Methods usable for coating of the composition for near infrared absorptive layer formation include various coating methods such as Mayer bar coating, doctor blade coating, gravure coating, gravure reverse coating, kiss reverse coating, three-roll reverse coating, slit reverse die coating, die coating, and Komma coating.

In the near infrared absorptive layer 3 of the optical filter 1 according to the present invention, the content of the foreign matter having a maximum diameter of 0.2 to 30 μm per unit area is preferably not more than 40/m². More preferably, the content of the foreign matter having a maximum diameter of 3 to 12 μm per unit area is 1 to 20/m². The foreign matter referred to herein is actually one which can be discriminated by observation under an optical microscope at a necessary magnification, and most of the foreign matter is observed as unshaped particles. The foreign matter can be classified according to sources into (1) dust or dirt in the air, (2) unreacted product of the starting material, contained in the colorant for developing the optical function, which are metal oxides in many cases and are insoluble in solvents, (3) various additives added to the resin, particularly release agents and the like. The maximum diameter of the foreign matter refers to diameter when the foreign matter is spherical; major axis when the foreign matter is in the form of a rugby ball; and the length of a maximum dimension part in the case of other forms.

The reason why the number of the foreign matter in the near infrared absorptive layer is limited is that a phenomenon in which haze is increased due to occurrence of microcracks (cracking) in the near infrared absorptive layer with the elapse of time during the use of the optical filer having a near infrared absorptive layer for a long period of time is influenced by the presence of foreign matter in the near infrared absorptive layer, and most of the microcracks are triggered by foreign matter in the near infrared absorptive layer.

From the viewpoint of avoiding microcracking, the smaller the size of the foreign matter, the better the results. Further, the lower the content of the foreign matter per unit area, the better the results. In actual production, however, a special method is required, e.g., for reducing the size of the foreign matter to a very small size or for removing most of the foreign matter. Furthermore, the time necessary for the size reduction and the removal is also long. Accordingly, the content of the foreign matter having a maximum diameter of 0.2 to 30 μm per unit area is preferably not more than 40/m² from the viewpoints of maintaining the practicality and substantially avoiding troubles.

When the content of the foreign matter having a maximum diameter of 0.2 to 30 μm per unit area exceeds 40/m², microcracking (cracking) is likely to occur in the near infrared absorptive layer with the elapse of time. Therefore, the haze is likely to be increased, and the haze upon the formation of the near infrared absorptive layer is high. This is unfavorable from the practical point of view. On the other hand, very close control of production conditions and production process are necessary for bringing the diameter of the foreign matter to less than 0.2 μm and bringing the content of the foreign matter per unit area to less than 1/m² from the initial stage of the production of the material constituting the near infrared absorptive layer. Therefore, disadvantageously, the efficiency for the provision of the material is poor, and the production cost is also increased. For the above reason, the number of the foreign matter having a maximum diameter of 0.2 to 30 μm is preferably 0 (zero)/m². When these various points for the production are taken into consideration, however, the lower limit of the number of the foreign matter is more preferably 1/m².

Forming the near infrared absorptive layer and bringing the diameter of the foreign matter in the near infrared absorptive layer and the content of the foreign matter per unit area to a predetermined preferred range are preferably carried out as follows.

The near infrared absorptive layer is formed by mixing the near infrared absorptive colorant and the binder resin and optional other additives together with a solvent and/or a diluent to dissolve or disperse the components to prepare a composition for near infrared absorptive layer formation, then removing foreign matter from the composition for near infrared absorptive layer formation, coating the composition for near infrared absorptive layer formation onto a transparent substrate 2, and drying the coated transparent substrate 2. Alternatively, the near infrared absorptive layer may be formed by melt kneading the near infrared absorptive colorant and the transparent binder resin with optional other additives to prepare a composition which is then coated by melt extrusion onto the transparent substrate 2.

In order to bring the maximum diameter of the foreign matter and content of the foreign matter per unit area in the near infrared absorptive layer to respective predetermined preferred ranges, the content of impurities in the near infrared absorptive colorant, the binder resin, additives such as antioxidants, the solvent and the like, which are materials used in the preparation of the composition for near infrared absorptive layer formation is preferably low. Further, the removal of impurities through the filtration of the as-prepared composition for near infrared absorptive layer formation, the step of preparing the composition for near infrared absorptive layer formation, the step of coating, and the step of drying are preferably carried out in a clean room.

The method for removing impurities through the filtration of the as-prepared composition for near infrared absorptive layer formation is most practical and efficient. In order to bring the content of the foreign matter having a diameter of 0.2 to 30 μm in the near infrared absorptive layer to not more than 40/m², the pore diameter of the filter used in the filtration is preferably as small as possible. The time necessary for the filtration increases with reducing the pore diameter due to an increase in filtration pressure. From this point of view, the pore diameter of the filter used in the filtration is preferably not more than 25 μm, more preferably not more than 10 μm, still more preferably not more than 5 μm. The filter used in the filtration is not particularly limited so far as the pore diameter is in the above-defined range. However, filament-type, felt-type, mesh-type, cartridge-type, or disk-type filters are suitable. The material for the filter is not particularly limited so far as the material has a filtering property and does not adversely affect the composition for near infrared absorptive layer formation. Preferred materials include, for example, stainless steel, polyethylene, polypropylene, nylon, cellulose acetate, cellulose, cellulose-mixed ester, tetrafluoroethylene (PTFE), polyester, or polycarbonate. The specifying and method of realizing the amount of the foreign matter described above are preferably applied not only to the near infrared absorptive layer 3 but also to layers having a color tone regulation function, a neon light shielding function, an antireflection function, an anti-glaring function or an anti-smudging function if these layers are provided by coating.

Transparent Substrate:

The transparent substrate 2 is provided for bearing thereon the near infrared absorptive layer 3 or additionally stacked various layers, or as a support of the optical filter 1. Accordingly, the type of the transparent substrate 2 is not particularly limited so far as the transparent substrate 2 is transparent to visible light and the near infrared absorptive layer 3 and other various layers can be stacked thereon. Preferably, however, the birefringence is low.

Examples of the transparent substrate 2 include films of resins, for example, polyesters, such as polyethylene terephthalate (PET) and polyethylene naphthalate (PEN), polyolefins, such as cyclic polyolefin, polyethylene, polypropylene, and polystyrene, vinyl resins, such as polyvinyl chloride and polyvinylidene chloride, polycarbonate, acrylic resins, triacetylcellulose (TAC), polyethersulfone, and polyether ketone. They may be used solely or as a laminate of identical or dissimilar films.

Regarding the transparency of the transparent substrate 2, when the transparent substrate 2 has a single-layer structure, the light transmittance in the visible region is preferably not less than 80%. The wording “transparent to” means that the material is preferably colorless and transparent. However, the material is not necessarily limited to a colorless and transparent material and may be a colored transparent material so far as the object of the present invention is not sacrificed. The light transmittance in the visible region is preferably as high as possible. From the fact that a light transmittance of not less than 50% is required as the final product, even when at least two layers are stacked for the transparent substrate, a light transmittance of 80% for each layer suffices for the transparent substrate 2. It is a matter of course that a larger number of layers constituting the transparent substrate 2 can be stacked when the light transmittance is higher. For this reason, the light transmittance of a single layer in the transparent substrate 2 is more preferably not less than 85%, most preferably not less than 90%. Reducing the thickness is also effective for improving the light transmittance.

The thickness of the transparent substrate 2 is not particularly limited so far as only the transparency requirement can be met. Preferably, however, the thickness is in the range of about 12 μm to about 300 μm from the viewpoint of workability. When the thickness is less than 12 μm, the transparent substrate 2 is excessively flexible and, consequently, tension or wrinkle is likely to occur due to tensile force produced at the time of working. Further, when the thickness exceeds 300 μm, the flexibility of the film is reduced and continuous winding in each step becomes difficult. Furthermore, in this case, disadvantageously, workability in the stacking of a plurality of layers for constituting the transparent substrate 2 is significantly deteriorated.

Electromagnetic Wave Shielding Layer:

The electromagnetic wave shielding layer which may be added to a near infrared absorptive laminate 4 is provided for shielding electromagnetic waves generated from an electric or electronic device to which the optical filter 1 is applied, especially a plasma display 6. A metallic mesh layer and a transparent conductive thin film layer are utilized in the electromagnetic wave shielding layer. A metallic mesh having a high level of electromagnetic wave shielding properties is preferred. The metallic mesh layer is formed by stacking a metallic foil on a transparent substrate and etching the foil into a mesh form. Therefore, it is common practice to interpose an adhesive layer between the transparent substrate 2 and the metallic mesh. The adhesive layer is formed of an adhesive such as an acrylic resin, a polyester resin, a polyurethane resin, a polyvinyl alcohol per se or a partially saponified product thereof, a vinyl chloride-vinyl acetate copolymer, an ethylene-vinyl acetate copolymer, a polyimide resin, an epoxy resin, or a polyurethane ester resin. The type of the metal is not particularly limited so far as the metallic mesh layer has an electromagnetic wave shielding capability. Examples thereof include copper, iron, nickel, chromium, aluminum, gold, silver, stainless steels, tungsten, and titanium. Among others, copper is preferred. A rolled copper foil, an electrolytic copper foil and the like are mentioned as the type of the copper foil. The electrolytic copper foil is particularly preferred, because an even foil having a thickness of not more than 10 μm can be provided and, in addition, upon blackening, the adhesion to chromium oxide or the like can be improved.

In the present invention, preferably, one side or both sides of the metallic mesh has been subjected to blackening treatment. The blackening treatment is a treatment method in which the surface of the metallic mesh is blackened with chromium oxide or the like. In the optical filter, this oxidized face is disposed so as to constitute a viewer side face. By virtue of the blackening treatment, external light on the surface of the optical filter is absorbed by chromium oxide or the like formed on the surface of the metallic mesh layer. Therefore, light scattering on the surface of the optical filter can be prevented, and an optical filter having a good transmittance can be realized.

The lower the open area ratio of the metallic mesh layer, the better the electromagnetic wave shielding capability. However, when the open area ratio is lowered, the light transmittance is lowered. Therefore, the open area ratio is preferably not less than 50%.

In the metallic mesh layer, the opening part and the non-opening part constitute a concave-convex part. Therefore, a flattening layer of a transparent resin having a larger thickness than the thickness of the metallic mesh layer may be stacked on the metallic mesh layer.

Anti-Smudging Layer:

The anti-smudging layer which may be added in the near infrared absorptive laminate 4 is a layer for preventing the deposition of dust or contaminant on the surface of the optical filter 1 due to inadvertent contact or contamination from the environment, or for facilitating the removal of dust or contaminants deposited thereon. For example, fluorocoating agents, silicone coating agents, and silicone-fluorocoating agents are usable, and, among them, silicone-fluorocoating agents are preferred. The thickness of the anti-smudging layer is preferably not more than 100 nm, more preferably not more than 10 nm, still more preferably not more than 5 nm. When the thickness of the anti-smudging layer exceeds 100 nm, the initial value of the anti-smudging property is excellent, but on the other hand, the durability is poor. The thickness of the anti-smudging layer is most preferably not more than 5 nm from the viewpoint of balance between the anti-smudging property and the durability.

Neon Light Shielding Layer:

The neon light shielding layer is provided for cutting off unnecessary luminescence around 595 nm emitted mainly upon excitation of neon gas in a plasma display. The neon light shielding layer may be formed in the same manner as in the formation of the near infrared absorptive layer, except that a neon light shielding colorant having an absorption maximum around this wavelength and a binder resin and other optional additives or the like are used. Preferred neon light shielding colorants include cyanine, oxonol, methine, subphthalocyanine, or porphyrin compounds. Porphyrin compounds are particularly preferred from the viewpoint of durability.

Antireflective Layer:

The antireflective layer which may be added to the near infrared absorptive laminate 4 is typically such that a high-refractive index layer and a low-refractive index layer are stacked in that order. Other laminate structure may also be adopted. The high-refractive index layer is, for example, a thin film of a material such as ZnO and TiO₂, or a transparent resin film in which fine particles of these materials have been dispersed. On the other hand, the low-refractive index layer is a thin film of SiO₂, a film of SiO₂ gel, or a fluorine-containing or fluorine- and silicon-containing transparent resin film. Stacking of the antireflection layer can lower the reflection of unnecessary light such as external light on the stacked side to enhance contrast of an image or a video image of a display onto which the optical filter is applied.

Anti-Glaring Layer:

The anti-glaring layer which may be additionally provided in the near infrared absorptive laminate 4 is, for example, a layer formed of a transparent resin with polystyrene resin, acrylic resin or other beads having a diameter of about several microns dispersed therein. The anti-glaring layer, when disposed on the front face of a display, can prevent scintillation caused in a particular position or direction in the display by the light diffusing property of the layer.

Pressure-Sensitive Adhesive Layer:

The pressure-sensitive adhesive layer used in the present invention is a layer formed of any transparent pressure-sensitive adhesive. The type of the pressure-sensitive adhesive and the like are not particularly limited so far as the light transmittance in the visible region is high. Specific examples thereof include acrylic pressure-sensitive adhesives, silicone pressure-sensitive adhesives, urethane pressure-sensitive adhesives, polyvinyl butyral pressure-sensitive adhesives, polyvinyl ether pressure-sensitive adhesives, and ethylene-vinyl acetate pressure-sensitive adhesives and the like.

The following Examples and Comparative Examples further illustrate but do not limit the present invention.

### EXAMPLE 1

An acrylic copolymer resin comprised of tricyclodecyl methacrylate represented by general formula (1), methyl methacrylate, and benzyl methacrylate (tradename: OPTOREZ oz 1330, Tg: 110° C., hydroxyl value: 0 (zero), acid value: 0 (zero), birefringence value: 4 nm, manufactured by Hitachi Chemical Co., Ltd.) was provided as a transparent binder resin. The binder resin was dissolved in methyl ethyl ketone at a solid content ratio of 20% (on a mass basis) to prepare a resin solution. Two near infrared absorptive colorants, that is, a diimmonium near infrared absorptive colorant in which R in general formula (3) represents trifluoromethyl to constitute a counter ion (X⁻) and R in general formula (2) represents n-butyl (tradename: CIR 1085, manufactured by Japan Carlit Co., Ltd.) (0.2 g/m²), and a phthalocyanine near infrared absorptive colorant (tradename: “YKR 3070,” manufactured by Yamamoto Chemical Inc.) (0.1 g/m²), were added to and thoroughly dispersed in the resin solution to prepare a coating solution. The coating solution was coated on a 100 μm-thick polyethylene terephthalate resin film (tradename: “A 4300,” manufactured by Toyobo Co., Ltd.) with a Mayer bar to a coating thickness on a dry basis of 5 μm. The coated film was dried at 100° C. for one min in an oven into which dry air is blown at a speed of 5 m/sec to form a near infrared absorptive layer. Thus, a near infrared absorptive filter was prepared.

### EXAMPLE 2

A near infrared absorptive filter was prepared in the same manner as in Example 1, except that only the diimmonium near infrared absorptive colorant used in Example 1 was used in an amount of 0.2 g/m² as the near infrared absorptive colorant.

### EXAMPLE 3

A near infrared absorptive filter was prepared in the same manner as in Example 1, except that an acrylic copolymer resin comprised of isobornyl methacrylate represented by general formula (1), methyl methacrylate, and benzyl methacrylate (Tg: 130° C., hydroxyl value: 0 (zero), acid value: 0 (zero), birefringence value: 9 nm) was used as the transparent binder resin.

### EXAMPLE 4

A near infrared absorptive filter was prepared in the same manner as in Example 1, except that an acrylic copolymer resin comprised of isobornyl methacrylate represented by general formula (1) and methyl methacrylate (Tg: 115° C., hydroxyl value: 0 (zero), acid value: 0 (zero), birefringence value: 13 nm) was used as the transparent binder resin.

### EXAMPLE 5

A near infrared absorptive filter was prepared in the same manner as in Example 1, except that the diimmonium near infrared absorptive colorant in the two near infrared absorptive colorants was replaced with a diimmonium near infrared absorptive colorant in which R in general formula (3) represents a 1,1,1,3,3,3-hexafluoro-2-propyl group to constitute a counter ion (X⁻) and R in general formula (2) represents n-butyl.

### EXAMPLE 6

A near infrared absorptive filter was prepared in the same manner as in Example 1, except that the diimmonium near infrared absorptive colorant in the two near infrared absorptive colorants was replaced with a diimmonium near infrared absorptive colorant in which R in general formula (3) represents a trifluoromethyl group to constitute a counter ion (X⁻) and R in general formula (2) represents ethylphenyl group.

### EXAMPLE 7

A near infrared absorptive filter was prepared in the same manner as in Example 1, except that, after the preparation of a coating solution, the coating solution was passed through a PTFE membrane filter (stock number: T 300 A 025 A, manufactured by Advantec Toyo Kaisha Ltd.) with a pore diameter of 3.0 μm to remove foreign matter.

### EXAMPLE 8

A near infrared absorptive filter was prepared in the same manner as in Example 1, except that, after the preparation of a coating solution, the coating solution was passed through a PTFE membrane filter (stock number: JCWP 02500, manufactured by Millipore Corporation) with a pore diameter of 10.0 μm to remove foreign matter.

### EXAMPLE 9

A fluorosilane compound (tradename: “KP 801M,” manufacturer: “The Shin-Etsu Chemical Co., Ltd.”) as a silicone-fluoroanti-smudging agent was coated on the near infrared absorptive filter prepared in Example 1 in its near infrared absorptive layer side to a thickness of 3.0 nm, and the coating was cured by drying to form an anti-smudging layer. Thus, a near infrared absorptive filter with an anti-smudging layer was prepared.

### EXAMPLE 10

An acrylic pressure-sensitive adhesive diluted with a solvent to a solid content of 20% (tradename: “AS 2140,” manufacturer: “Ipposha Oil Industries Co., Ltd.”) was coated onto a release film (tradename: “E7002,” manufacturer: “Toyobo Co., Ltd.”) in its release face with a doctor blade to a thickness of 25 μm on a dry basis, and the coated film was dried at 100° C. for one min in an oven into which dry air is blown at a speed of 5 m/sec to from a pressure-sensitive adhesive layer. Thus, a pressure-sensitive adhesive film was applied to the near infrared absorptive filter prepared in Example 1 with a laminate roller under conditions of roller temperature 23° C. and linear pressure 0.035 kg/cm so that the pressure-sensitive adhesive film was brought into contact with the near infrared absorptive layer side of the near infrared absorptive filter to prepare a near infrared absorptive filter with a pressure-sensitive adhesive layer.

### EXAMPLE 11

On the near infrared absorptive filter prepared in Example 1 in its near infrared absorptive layer side were sputtered an SiO₁N₁ film as a first inorganic optical thin film, a thin film from an indium tin oxide compound (ITO), a Ta₂O₅ film, and an SiO₂ film as an outermost layer in that order to form an antireflective layer. In this case, the thickness was 23 nm for the SiO₁N₁ film, 60 nm for the ITO film, 53 nm for the Ta₂O₅ film, and 90 nm for the SiO₂ film. Thus, a near infrared absorptive filter with an antireflective layer was prepared.

### EXAMPLE 12

A mixed liquid prepared by dispersing acrylic resin particles (tradename: “ART PEARL,” manufactured by Negami Chemical Industrial Co. Ltd.) in dipentaerythritol hexaacrylate was coated by a Mayer bar onto the near infrared absorptive filter prepared in Example 1 in its near infrared absorptive layer side to a thickness of 4 μm on a dry basis, and the coatig was cured by drying to form an anti-glaring layer. Thus, a near infrared absorptive filter with an anti-glaring layer was prepared.

### EXAMPLE 13

A 100 μm-thick polyethylene terephthalate resin film (tradename: “A 4300,” manufactured by Toyobo Co., Ltd.) was provided. A copper foil having one surface subjected to chromate treatment for blackening (tradename: EXP-WS, thickness 9 μm, manufactured by Furukawa Circuit Foil Co., Ltd.) applied by dry lamination to the polyethylene terephthalate resin film with the aid of a urethane adhesive. A resist was then coated onto the above copper foil, and exposure and development were then carried out to remove unnecessary copper foil parts by etching, whereby an electromagnetic wave shielding layer having a metallic mesh with a size of 300 μm square and a line width of 10 μm was formed. The near infrared absorptive colorant-containing coating solution used in Example 1 was coated by a Mayer bar onto the metallic mesh to a thickness of 5 μm on a dry basis, and the coating was dried at 100° C. for one min in an oven into which dry air was blown at a speed of 5 m/sec to form a near infrared absorptive layer. Thus, a near infrared absorptive filter with an electromagnetic wave shielding function was prepared.

### EXAMPLE 14

A near infrared absorptive filter was prepared in the same manner as in Example 1, except that an acrylic copolymer resin comprised of cyclohexyl methacrylate represented by general formula (1), methyl methacrylate, and 2-ethylhexyl acrylate (tradename: IRG-205, Tg: 90° C., hydroxyl value: 3, acid value: 0 (zero), birefringence value: 14 nm, manufactured by Nippon Shokubai Kagaku Kogyo Co., Ltd.) was used as a transparent binder resin, and three near infrared absorptive colorants, that is, a diimmonium near infrared absorptive colorant (tradename: CIR 1085, manufactured by Japan Carlit Co., Ltd.) (0.2 g/m²) and two phthalocyanine near infrared absorptive colorants (tradename: “YKR 3070” and “YKR 3181” (each 0.1 g/m²), were used as the near infrared absorptive colorants.

### COMPARATIVE EXAMPLE 1

A near infrared absorptive filter was prepared in the same manner as in Example 1, except that polymethyl methacrylate (tradename: BR-60, Tg: 75° C., hydroxyl value: 0 (zero), acid value: 1, birefringence value: 50 nm, manufactured by Mitsubishi Rayon Co., Ltd.) was used as the transparent binder resin.

### COMPARATIVE EXAMPLE 2

A near infrared absorptive filter was prepared in the same manner as in Example 1, except that a polyester resin (Tg: 110° C., acid value: 26, hydroxyl value: 19, birefringence value: 20 nm) was used as the transparent binder resin.

(Evaluation Methods)

Immediately after the preparation and after exposure to an environment of 60° C. and 90% in a thermo-hygrostat for 1000 hr, each item of transparency (haze), luminous transmittance, and near infrared transmittance was measured for near infrared absorptive filters prepared in Examples 1 to 14 and Comparative Examples 1 and 2. The results are shown in “Table 1” below.

The above items and other items in “Table 1” below were measured under the following conditions.

Transparency (haze): determined with a color computer (tradename: “SM-C,” manufactured by Suga Test Instruments Co., Ltd.) for specimens having a size of 50 mm×50 mm taken off from the near infrared absorptive filters.

Luminous transmittance and near infrared region transmittance: measured with a spectrophotometer (tradename: “UV-3100 PC,” manufactured by Shimadzu Seisakusho Ltd.) for specimens having a size of 50 mm×50 mm taken off from the near infrared absorptive filters.

Image quality: An optical filter was disposed on the front face of a plasma display, and the image was visually evaluated.

Birefringence value: A value obtained by measuring a phase difference of a single path of an He-Ne laser at a part (5 mm) near a gate in an injection molded product; see Purasuchikku Eigi (PLASTICS AGE) 1999. January. p. 134-138.

Number of foreign matter: For 16 specimens having a size of 250 mm×250 mm taken off from each near infrared absorptive film, the near infrared absorptive film was observed from a vertical direction under an optical microscope with a measuring scale to determine the size and number of foreign matter, and the number of foreign matter having a maximum diameter of 0.2 μm to 30 μm per m² and the number of foreign matter having a maximum diameter of 3 μm to 12 μm per m² were calculated.

Crack: For 16 specimens having a size of 250 mm×250 mm taken off from each near infrared absorptive film, the near infrared absorptive film was observed from a vertical direction under an optical microscope to inspect whether or not a crack was present per m².

TABLE 1

| | Ex. 1 | Ex. 2 | Ex. 3 | Ex. 4 |
|---|---|---|---|---|
| Transparent substrate | PET | PET | PET | PET |
| IR absorptive layer | | | | |
| Colorant | | | | |
| Colorant 1 | Diimmonium- | Diimmonium- | Diimmonium- | Diimmonium- |
| | based | based | based | based |
| Colorant 2 | Phthalocyanine- | — | Phthalocyanine- | Phthalocyanine- |
| | based | | based | based |
| Transparent binder resin | | | | |
| Constitutional unit 1 | Tricyclodecyl | Tricyclodecyl | Isobornyl | Isobornyl |
| | methacrylate | methacrylate | methacrylate | methacrylate |
| Constitutional unit 2 | Benzyl | Benzyl | Benzyl | — |
| | methacrylate | methacrylate | methacrylate | |
| Constitutional unit 3 | Methyl | Methyl | Methyl | Methyl |
| | methacrylate | methacrylate | methacrylate | methacrylate |
| Birefringence (nm) | 4 | 4 | 9 | 13 |
| Tg (° C.) | 110 | 110 | 130 | 115 |
| Hydroxyl value | 0 | 0 | 0 | 0 |
| Acid value | 0 | 0 | 0 | 0 |
| Filtration filter | | | | |
| Pore diameter | — | — | — | — |
| Foreign matter content, /m² | | | | |
| Max. diameter 0.2 to 30 μm | — | — | — | — |
| Max. diameter 3 to 12 μm | — | — | — | — |
| Other functional layer | — | — | — | — |
| Evaluation immediately | | | | |
| after preparation | | | | |
| Haze | 0.5% | 0.6% | 0.5% | 0.6% |
| Luminous transmittance | 72% | 85% | 75% | 77% |
| NIR transmittance | 4.3% | 4.2% | 4.1% | 4.1% |
| Image quality | High definition | High definition | High definition | High definition |
| Crack | — | — | — | — |
| Appearance | — | — | — | — |
| Evaluation after moist | | | | |
| heat resistance test | | | | |
| Haze | 0.4% | 0.5% | 0.5% | 0.5% |
| Luminous transmittance | 71% | 87% | 73% | 75% |
| NIR transmittance | 4.1% | 4.0% | 4.0% | 4.5% |
| Image quality | High definition | High definition | High definition | High definition |
| Crack | — | — | — | — |
| Appearance | — | — | — | — |
| | Ex. 5 | Ex. 6 | Ex. 7 | Ex. 8 |
| Transparent substrate | PET | PET | PET | PET |
| IR absorptive layer | | | | |
| Colorant | | | | |
| Colorant 1 | Diimmonium- | Diimmonium- | Diimmonium- | Diimmonium- |
| | based | based | based | based |
| Colorant 2 | Phthalocyanine- | Phthalocyanine- | Phthalocyanine- | Phthalocyanine- |
| | based | based | based | based |
| Transparent binder resin | | | | |
| Constitutional unit 1 | Tricyclodecyl | Tricyclodecyl | Tricyclodecyl | Tricyclodecyl |
| | methacrylate | methacrylate | methacrylate | methacrylate |
| Constitutional unit 2 | Benzyl | Benzyl | Benzyl | Benzyl |
| | methacrylate | methacrylate | methacrylate | methacrylate |
| Constitutional unit 3 | Methyl | Methyl | Methyl | Methyl |
| | methacrylate | methacrylate | methacrylate | methacrylate |
| Birefringence (nm) | 4 | 4 | 4 | 4 |
| Tg (° C.) | 110 | 110 | 110 | 110 |
| Hydroxyl value | 0 | 0 | 0 | 0 |
| Acid value | 0 | 0 | 0 | 0 |
| Filtration filter | | | | |
| Pore diameter | — | — | 3.0 μm | 10.0 μm |
| Foreign matter content, /m² | | | | |
| Max. diameter 0.2 to 30 μm | — | — | 4 | 28 |
| Max. diameter 3 to 12 μm | — | — | 0 | 15 |
| Other functional layer | — | — | — | — |
| Evaluation immediately | | | | |
| after preparation | | | | |
| Haze | 0.5% | 0.5% | 0.5% | 0.6% |
| Luminous transmittance | 81% | 81% | 81% | 82% |
| NIR transmittance | 4.3% | 4.2% | 4.3% | 4.3% |
| Image quality | High definition | High definition | High definition | High definition |
| Crack | — | — | Free | Free |
| Appearance | — | — | OK | OK |
| Evaluation after moist | | | | |
| heat resistance test | | | | |
| Haze | 0.5% | 0.6% | 0.6% | 0.7% |
| Luminous transmittance | 80% | 81% | 80% | 81% |
| NIR transmittance | 4.1% | 4.0% | 4.1% | 4.0% |
| Image quality | High definition | High definition | High definition | High definition |
| Crack | — | — | Free | Free |
| Appearance | — | — | OK | OK |
| | Ex. 9 | Ex. 10 | Ex. 11 | Ex. 12 |
| Transparent substrate | PET | PET | PET | PET |
| IR absorptive layer | | | | |
| Colorant | | | | |
| Colorant 1 | Diimmonium- | Diimmonium- | Diimmonium- | Diimmonium- |
| | based | based | based | based |
| Colorant 2 | Phthalocyanine- | Phthalocyanine- | Phthalocyanine- | Phthalocyanine- |
| | based | based | based | based |
| Transparent binder | | | | |
| resin | | | | |
| Constitutional unit 1 | Tricyclodecyl | Tricyclodecyl | Tricyclodecyl | Tricyclodecyl |
| | methacrylate | methacrylate | methacrylate | methacrylate |
| Constitutional unit 2 | Benzyl | Benzyl | Benzyl | Benzyl |
| | methacrylate | methacrylate | methacrylate | methacrylate |
| Constitutional unit 3 | Methyl | Methyl | Methyl | Methyl |
| | methacrylate | methacrylate | methacrylate | methacrylate |
| Birefringence (nm) | 4 | 4 | 4 | 4 |
| Tg (° C.) | 110 | 110 | 110 | 110 |
| Hydroxyl value | 0 | 0 | 0 | 0 |
| Acid value | 0 | 0 | 0 | 0 |
| Filtration filter | | | | |
| Pore diameter | — | — | — | — |
| Foreign matter content, /m² | | | | |
| Max. diameter 0.2 to | — | — | — | — |
| 30 μm | | | | |
| Max. diameter 3 to 12 μm | — | — | — | — |
| Other functional | Anti- | Pressure- | Antireflection | Anti-glaring |
| layer | smudging | sensitive | layer | layer |
| | layer | adhesive layer | | |
| Evaluation | | | | |
| immediately after | | | | |
| preparation | | | | |
| Haze | 0.7% | 0.5% | 0.7% | 0.5% |
| Luminous | 76% | 75% | 74% | 76% |
| transmittance | | | | |
| NIR transmittance | 4.5% | 4.6% | 4.4% | 4.5% |
| Image quality | High | High definition | High definition | High definition |
| | definition | | | |
| Crack | — | — | — | — |
| Appearance | — | — | — | — |
| Evaluation after | | | | |
| moist heat resistance | | | | |
| test | | | | |
| Haze | 0.8% | 0.6% | 0.8% | 0.4% |
| Luminous | 82% | 80% | 75% | 75% |
| transmittance | | | | |
| NIR transmittance | 4.4% | 4.5% | 4.5% | 4.4% |
| Image quality | High | High definition | High definition | High definition |
| | definition | | | |
| Crack | — | — | — | — |
| Appearance | — | — | — | — |
| | Ex. 13 | Ex. 14 | Comp. Ex. 1 | Comp. Ex. 2 |
| Transparent substrate | PET | PET | PET | PET |
| IR absorptive layer | | | | |
| Colorant | | | | |
| Colorant 1 | Diimmonium- | Diimmonium- | Diimmonium- | Diimmonium- |
| | based | based | based | based |
| Colorant 2 | Phthalocyanine- | Phthalocyanine- | Phthalocyanine- | Phthalocyanine- |
| | based | based | based | based |
| Transparent binder | | | | |
| resin | | | | |
| Constitutional unit 1 | Tricyclodecyl | Cyclohexyl | Methyl | Polyester |
| | methacrylate | methacrylate | methacrylate | |
| Constitutional unit 2 | Benzyl | 2-Ethylhexyl | | |
| | methacrylate | methacrylate | | |
| Constitutional unit 3 | Methyl | Methyl | | |
| | methacrylate | methacrylate | | |
| Birefringence (nm) | 4 | 14 | 50 | 20 |
| Tg (° C.) | 110 | 90 | 75 | 110 |
| Hydroxyl value | 0 | 3 | 1 | 19 |
| Acid value | 0 | 0 | 0 | 26 |
| Filtration filter | | | | |
| Pore diameter | — | — | — | — |
| Foreign matter content, /m² | | | | |
| Max. diameter 0.2 to | — | — | — | — |
| 30 μm | | | | |
| Max. diameter 3 to 12 μm | — | — | — | — |
| Other functional | Electromagnetic | — | — | — |
| layer | wave shielding | | | |
| | layer | | | |
| Evaluation | | | | |
| immediately after | | | | |
| preparation | | | | |
| Haze | 0.8% | 0.5% | 2.6% | 2.3% |
| Luminous | 78% | 68% | 64% | 61% |
| transmittance | | | | |
| NIR transmittance | 4.1% | 3.3% | 10.6% | 13.1% |
| Image quality | High definition | High definition | Double image | Double image |
| Crack | — | — | — | — |
| Appearance | — | — | — | — |
| Evaluation after | | | | |
| moist heat resistance | | | | |
| test | | | | |
| Haze | 0.8% | 0.4% | 3.5% | 4.6% |
| Luminous | 77% | 68% | 21% | 32% |
| transmittance | | | | |
| NIR transmittance | 4.1% | 3.4% | 52.3% | 72.4% |
| Image quality | High definition | High definition | Double image | Double image |
| Crack | — | — | — | — |
| Appearance | — | — | — | — |

In the items in “Table 1,” the amount of the colorant added is in g/m², the birefringence is in nm, the acid value and the hydroxyl value are in mgKOH/g, and the NIR transmittance immediately after the production and after the moist heat resistance test refers to the maximum light transmittance in a near infrared region (wavelength: 800 nm to 1200 nm).

As shown in “Table 1,” the optical filters of Examples 1 to 14 were excellent in all the items of the haze, the luminous transmittance, the near infrared region transmittance, and the image quality immediately after the production. These excellent properties immediately after the production remained substantially unchanged even after exposure to an environment of temperature 60° C. and humidity 90% for 1000 hr after the production, indicating that these optical filters have resistance to moist heat which is satisfactory from the practical point of view. By contrast, due to large birefringence values, the optical filters of Comparative Examples 1 and 2, when disposed on the front face of a plasma display, caused a double image. Further, for Comparative Examples 1 and 2 wherein Tg and/or acid value/hydroxyl value of the transparent binder resin were outside the predetermined range, the haze, the luminous transmittance, and the near infrared region transmittance immediately after the production were poor, and these properties were further deteriorated after exposure to an environment of temperature 60° C. and humidity 90% for 1000 hr. Therefore, it can be said that the optical filters of Comparative Examples 1 and 2 lack in practicality.

For the optical filters of Examples 5 and 6 wherein the composition for near infrared absorptive layer formation was filtered through a filter with a preferred pore diameter to remove impurities before the composition was used for the formation of the near infrared absorptive layer, the number of foreign matter was very small and, hence, the optical filters were free from cracking caused with the elapse of time and did not cause any increase in haze.

### INDUSTRIAL APPLICABILITY

The optical filter according to the present invention, when disposed on the front face of a display, can suppress the occurrence of a double image and can realize a high-definition image. Therefore, the optical filter according to the present invention is suitable for use in displays, particularly plasma displays.

1. An optical filter having a multilayer structure comprising at least a transparent substrate and a near infrared absorptive layer formed on the transparent substrate, the near infrared absorptive layer comprising an acrylic resin containing a near infrared absorptive colorant capable of absorbing a near infrared radiation, said acrylic resin having a birefringence value in the range of 0 (zero) to 15 nm.

2. The optical filter according to claim 1, wherein said acrylic resin is an acrylic copolymer resin comprising:
(1) methyl methacrylate; and
(2) one or at least two (meth)acrylic acid compounds which can negate a negative birefringence value possessed by said methyl methacrylate to bring the birefringence value of said copolymer to 0 (zero) to 15 nm.

3. The optical filter according to claim 1, wherein said acrylic resin is an acrylic copolymer resin comprising:
(1) methyl methacrylate; and
(2) one or at least two compounds represented by general formula (1) 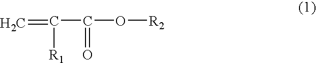
wherein R¹ represents a hydrogen atom or an alkyl group; and R² represents an alicyclic group or an aromatic ring group.

4. The optical filter according to claim 3, wherein the compound represented by general formula (1) is at least one compound in which R² represents an alicyclic group, and at least one compound in which R² represents an aromatic ring group.

5. The optical filter according to claims 1, wherein said acrylic resin has a glass transition temperature of 80° C. to 150° C.

6. The optical filter according to claims 1, wherein said near infrared absorptive colorant is a diimmonium compound represented by general formula (2): 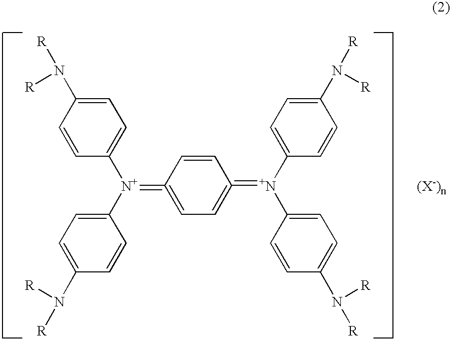
wherein R's, which may be the same or different, represent hydrogen or an alkyl, aryl, hydroxyl, phenyl, or alkyl halide group; X represents a monovalent or divalent anion; and n is 1 or 2.

7. The optical filter according to claims 1, wherein X in general formula (2) represents a monovalent or divalent anion having a sulfonylimidic acid ion structure represented by general formula (3): 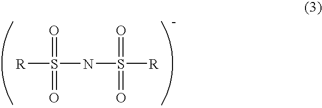
wherein R's, which may be the same or different, represent hydrogen, a halogen, a substituted or unsubstituted alkyl group, or a substituted or unsubstituted aryl group.

8. The optical filter according to claim 6, wherein said near infrared absorptive colorant contains a phthalocyanine compound in addition to the diimmonium compound represented by general formula (2).

9. The optical filter according to claims 1, wherein the content of foreign matter, of which the maximum diameter per unit area of said near infrared absorptive layer is 0.2 μm to 30 μm, is not more than 40/m².

10. The optical filter according to claim 9, wherein the content of foreign matter, of which the maximum diameter per unit area of said near infrared absorptive layer is 3 μm to 12 μm, is 1/m² to 20/m².

11. The optical filter according to claims 1, which further comprises one or at least two layers having one or at least two functions of an electromagnetic wave shielding function, a color tone regulating function, a neon light shielding function, an antireflective function, an anti-glaring function, and an anti-smudging function.

12. The optical filter according to claims 1, which further comprises a pressure-sensitive adhesive layer for application to an object, or a release film for said pressure-sensitive adhesive layer and for protecting said pressure-sensitive adhesive layer.

13. A display characterized by comprising the optical filter according to claim 1 disposed on the front face of a display.
